(19) United States
(12) Patent Application Publication
(10) Pub. No.: US 2017/0303694 A1
(43) Pub. Date: Oct. 26, 2017

(54) ELECTROTHERMAL MATTRESS COVER

(71) Applicant: Zhejiang Natural Travel Goods Co., Ltd., Taizhou City (CN)

(72) Inventors: Yonghui XIA, Taizhou City (CN); Jinglong CAO, Taizhou City (CN); Zhiwang PAN, Taizhou City (CN); Zhijian MA, Taizhou City (CN)

(21) Appl. No.: 15/215,906

(22) Filed: Jul. 21, 2016

(30) Foreign Application Priority Data
Apr. 21, 2016 (CN) 2016203496662
May 27, 2016 (CN) 2016205021066
May 27, 2016 (CN) 2016205040993

(51) Int. Cl. A47C 21/04; A47G 9/08; A47C 31/10; A44B 19/00; A44B 18/00; A44B 17/00; H05B 3/36; A44B 1/00

(52) U.S. Cl. CPC A47C 21/048; H05B 3/36; A47G 9/086; A47C 31/105; A44B 1/00; A44B 18/0015; A44B 18/0011; A44B 17/00; A44B 19/00

(57) ABSTRACT

The present invention provides electrothermal mattress cover, electrothermal sleeping bag/mattress cover, and temperature control sleeping bag. The electrothermal mattress cover comprises a cloth cover and a heating sheet; the cloth cover at least covers or wraps the upper surface of the heating sheet; the cloth cover is provided with corner connecting pieces at its corners, for connecting the heating sheet; the heating sheet comprises a heating wire fixed within an interlayer between two adhesive tapes, and an outer cover wrapping the two adhesive tapes; the outgoing end of the heating wire goes through the tapes and the outer cover; the heating wire is bound to the outer cover by waterproof binding materials; and the outgoing end of the heating sheet is used for power connection.

### TECHNICAL FIELD

The invention relates to the technical field of bedding, particularly to an electrothermal mattress cover, an electrothermal sleeping bag/mattress cover, and a temperature control sleeping bag.

### BACKGROUND ART

A sleeping bag is a common product used outdoors. In cold seasons or areas, the mere thermal insulation performance of the sleeping bag itself cannot satisfy the requirements of a user, thus it is necessary to provide a heating device. Current sleeping bags with heating function are generally for outdoor use in winter. The overall material is thick, and the sleeping bags are bulky.

An electric blanket (electric bed mat) is a heating appliance used in bed. It increases the temperature in the bed while people are sleeping so that they may feel warm. It also dehumidifies the quilt. It has low power consumption, adjustable temperature and is user-friendly and widely used.

There are various types of electric blankets, but they are somehow defective because:

(1) Most electric blankets are integrated with the outer cover, making it difficult to disassemble them and impossible to wash them, and thus, they become unhygienic after a long term of service.

(2) The circuit in an electric blanket becomes aged after a long term of service. The electric blanket itself has a poor waterproofness, and if it encounters water in use, there might be a short circuit, even possibly leading to a fire, which is a potential safety hazard.

(3) The heating material is hard and feels poor.

### DISCLOSURE OF THE INVENTION

The purpose of the invention is to provide an electrothermal mattress cover to solve the technical problems in the art that it is difficult to remove the heating components from an electric blanket, that it is impossible to wash and replace the outer cover and that the waterproof, insulating and inflaming retarding effect is less than satisfactory.

The electrothermal mattress cover provided by the invention includes a cloth cover and a heating sheet.

The cloth cover at least covers or wraps an upper surface of the heating sheet; the cloth cover is provided with corner connecting pieces at its corners, for connecting the heating sheet.

The heating sheet includes a heating wire fixed within the interlayer between two adhesive tapes, and an outer cover wrapping the two adhesive tapes. An outgoing end of the heating wire goes through the adhesive tapes and the outer cover, and the heating wire is bound to the outer cover by waterproof binding materials.

The outgoing end of the heating sheet is used for power connection.

The electrothermal mattress cover is easy to disassemble and a heating sheet may be placed in it and taken out as needed. The cloth cover may be used as a common mattress cover, and may be replaced and washed at any time.

The heating sheet is provided with adhesive tapes in it which provide waterproof, insulating and flame retardant effects, and are protective for the heating wire, making it very safe.

A preferred technical solution of the invention is that the upper surface of the heating sheet is provided with fixing straps at its corners, and both ends of the fixing straps are fixed onto the heating sheet, cooperating with the upper surface of the heating sheet to form fixing rings.

The cloth cover is provided on the upper surface of the heating sheet, and the corners of the cloth cover are threaded through the fixing rings and fixed.

The cloth cover only covers the upper surface, making it easy to disassemble the cloth cover and the heating sheet and to wash and replace them.

A preferred technical solution of the invention is that the cloth cover is of a bag structure, and the cloth cover is provided, on one side of its back, with a large opening allowing the heating sheet to enter, and provided, on the other side of the back, with a small opening allowing the outgoing end of the heating sheet to enter or exit.

A preferred technical solution of the invention is that an opening connecting piece is provided at the large opening on the back of the cloth cover.

A preferred technical solution of the invention is that the corner connecting pieces are ropes, snap fasteners or Velcro, and the opening connecting piece is a zipper, rope, button, snap fastener or Velcro.

A preferred technical solution of the invention is that the types of the heating wire include a silicone heating wire, a carbon fiber heating wire, a Teflon alloy heating wire and a glass fiber heating wire.

A preferred technical solution of the invention is that the upper surface of the cloth cover is made of a single layer of material or multiple layers of laminated materials.

A preferred technical solution of the invention is that the single layer of material is a flexible material including knitted fabric and lint.

The multiple layers of laminated materials are, from top to bottom, respectively flexible material including knitted fabric and lint, sponge and cotton insulation.

It feels more soft and comfortable when there are multiple layers of laminated materials.

A preferred technical solution of the invention is that the heating wire is arranged or wound in an S-shape configuration, clip-shape configuration or grid-shape configuration.

A preferred technical solution of the invention is that the electrothermal mattress cover further includes a power source and a temperature control device.

The outgoing end of the heating wire is connected with the power source via the temperature control device.

The power source is a lithium battery and provided with a USB interface so that it can be used as a mobile power pack for charging electronic products such as a mobile phone.

A preferred technical solution of the invention is that the heating sheet is further provided with a temperature sensor which is connected with the temperature control device, enabling automatic adjustment of temperature grades so that it automatically stays at a suitable temperature.

A preferred technical solution of the invention is that the heating sheet is further provided with a positive temperature coefficient thermistor, and the resistance of the positive temperature coefficient thermistor is adjusted with a change of temperature, to achieve adjustment of temperature grades.

The thermistor is used to control the temperature of the heating sheet. As the temperature of the heating sheet increases to a set value, the resistance of the positive temperature coefficient thermistor increases significantly, thereby reducing the intensity of current and suspending the heating. After the temperature of the heating sheet decreases, the resistance of the positive temperature coefficient thermistor decreases accordingly, thereby increasing the intensity of current and improving the heating strength.

The temperature control is achieved by the positive temperature coefficient thermistor with its own properties, thereby simplifying the circuit and increasing the reliability of the temperature control device.

The electrothermal sleeping bag/mattress cover provided by the invention includes a cloth cover and a heating sheet.

The cloth cover includes an upper surface of the cloth cover and a lower surface of the cloth cover; one long side of the upper surface of the cloth cover and one long side of the lower surface of the cloth cover are fixedly connected by sewing; the other long side and at least one short side of the upper surface of the cloth cover and those of the lower surface of the cloth cover are connected in an openable and closable manner.

The heating sheet is provided on the inner side of the upper surface of the cloth cover by sewing or attachment.

When three respective sides of the upper surface and the lower surface of the cloth cover are connected, the cloth cover presents a bag structure, becoming a sleeping bag with heating function. Likewise, as the cloth cover is thin, it substantially presents a form of sheet once being folded, thus it may be used as a mattress cover (electric blanket) with heating function.

The heating sheet is provided with adhesive tapes in it which provide a waterproof and flame retardant effect, and are protective for the heating wire, making it very safe.

A preferred technical solution of the invention is that the heating sheet includes a heating wire fixed within the interlayer between two adhesive tapes, and an outer cover wrapping the two adhesive tapes; the outgoing end of the heating wire goes through the tapes and the outer cover, and the heating wire is bound to the outer cover by waterproof binding materials.

The outgoing end of the heating sheet is used for power connection.

A preferred technical solution of the invention is that the other long side and at least one short side of the upper surface of the cloth cover and those of the lower surface of the cloth cover are connected by zippers.

A preferred technical solution of the invention is that an opening is provided on the inner side of the upper surface of the cloth cover allowing the heating sheet to enter and an opening connecting piece is provided at the opening.

Providing the opening connecting piece makes it easy for the heating sheet to enter, so that it is easy to wash the cloth cover and more options of use are provided.

A preferred technical solution of the invention is that the opening connecting piece is a zipper, rope, button, snap fastener or Velcro.

A preferred technical solution of the invention is that the types of the heating wire include a silicone heating wire, a carbon fiber heating wire, a Teflon alloy heating wire and a glass fiber heating wire.

A preferred technical solution of the invention is that the upper surface of the cloth cover is made of a single layer of material or multiple layers of laminated materials.

A preferred technical solution of the invention is that the single layer of material is a flexible material including knitted fabric and lint.

The multiple layers of laminated materials are, from top to bottom, respectively flexible material including knitted fabric and lint, sponge and cotton insulation.

It feels more soft and comfortable when there are multiple layers of laminated materials.

A preferred technical solution of the invention is that the heating wire is arranged or wound in an S-shape configuration, clip-shape configuration or grid-shape configuration.

A preferred technical solution of the invention is that the electrothermal sleeping bag/mattress cover further comprises a power source and a temperature control device.

The outgoing end of the heating wire is connected with the power source via the temperature control device.

The power source is a lithium battery and provided with a USB interface so that it can be used as a mobile power pack for charging electronic products such as a mobile phone.

A preferred technical solution of the invention is that the heating sheet is further provided with a temperature sensor which is connected with the temperature control device, enabling automatic adjustment of temperature grades so that it automatically stays at a suitable temperature.

A preferred technical solution of the invention is that the heating sheet is further provided with a positive temperature coefficient thermistor, and the resistance of the positive temperature coefficient thermistor is adjusted with a change of temperature, to achieve adjustment of temperature grades.

The thermistor is used to control the temperature of the heating sheet. As the temperature of the heating sheet increases to a set value, the resistance of the positive temperature coefficient thermistor increases significantly, thereby reducing the intensity of current and suspending the heating. After the temperature of the heating sheet decreases, the resistance of the positive temperature coefficient thermistor decreases accordingly, thereby increasing the intensity of current and improving the heating strength.

The temperature control is achieved by the positive temperature coefficient thermistor with its own properties, thereby simplifying the circuit and increasing the reliability of the temperature control device.

The temperature control sleeping bag provided in the invention includes an inner layer, an outer layer, at least one flexible heating sheet, a power source and at least one temperature control device;

the flexible heating sheet includes a cloth bag and alloy fiber provided inside the cloth bag;

the flexible heating sheet is provided within an interlayer formed between the inner layer and the outer layer, and the flexible heating sheet is electrically connected with the power source through the temperature control device.

The alloy fiber generally refers to a material used for producing soft industrial metal. Due to the unique chemical element association, the alloy fiber has good electrical conductivity and thermal conductivity, high strength, high elasticity, flexibility, wear resistance and corrosion resistance, and at the same time, the alloy fiber has for example properties of shielding, anti-magnetism and anti-radiation, and is unlikely to produce an electrostatic effect.

In a case that the alloy fiber is adopted for the heating component, there may be characteristics of fast heating, high electricity-heat transformation rate, foldability, washability and sewability. Furthermore, the alloy fiber is soft and light, which makes the user feel better and enables an improvement of the sleeping quality.

A preferred technical solution of the invention is that at least one opening is provided at a place where the inner layer and the outer layer are connected.

The interlayer may be opened by the opening, so that a position of the flexible heating sheet can be adjusted freely in accordance with a body shape or a requirement of a user.

A preferred technical solution of the invention is that a zipper, a rope, a snap fastener or a button is provided at the opening, for implementing opening or closing of the opening.

A preferred technical solution of the invention is that one surface of the cloth bag is provided with a hook layer of Velcro, and an inner surface of the outer layer is covered with a fiber loop layer of the Velcro, thus making the position of the flexible heating sheet adjustable inside the interlayer.

By Velcro structure, the flexible heating sheet may be fixed at a set position, which prevents the flexible heating sheet from moving or shifting; and the flexible heating sheet can also be moved or taken out conveniently when the position needs to be adjusted or the sleeping bag needs to be washed.

A preferred technical solution of the invention is that number of the at least one temperature control device is one, which controls all the flexible heating sheets to work synchronously; or the number of the at least one temperature control device is equal to that of the flexible heating sheets, for respectively controlling the corresponding flexible heating sheet to work.

A preferred technical solution of the invention is that there are two flexible heating sheets which are provided in an interlayer of a lower layer of the sleeping bag, and positions where the two flexible heating sheets locate correspond to the waist and the feet of a human body, respectively.

The feet of a person present low temperature during the sleeping of the person, and thus the sleeping quality of the person may be improved if a heating sheet is provided at the feet.

A preferred technical solution of the invention is that the temperature control sleeping bag further includes a temperature sensor; the temperature sensor is provided inside the flexible heating sheet, and the temperature sensor is connected with the temperature control device, for implementing an adjustment of the temperature grades.

The temperature sensor is adopted to control a range of the heating temperature of the flexible heating sheet, thereby enabling the flexible heating sheet to maintain at a suitable temperature automatically.

A preferred technical solution of the invention is that the temperature control device is provided with a positive temperature coefficient thermistor therein, and resistance of the positive temperature coefficient thermistor is adjusted with a change of temperature, for implementing an adjustment of temperature grades.

A thermistor is used to control the temperature of the flexible heating sheet: as the temperature of the flexible heating sheet increases to a set value, the resistance of the positive temperature coefficient thermistor increases significantly, thereby reducing the intensity of current and suspending the heating of the alloy fiber. After the temperature of the flexible heating sheet decreases, the resistance of the positive temperature coefficient thermistor decreases accordingly, thereby increasing the intensity of current and improving the heating strength of the alloy fiber.

The temperature control is implemented by the positive temperature coefficient thermistor with its own properties, thereby simplifying the circuit and increasing the reliability of the temperature control device.

A preferred technical solution of the invention is that the power source is a lithium battery.

A preferred technical solution of the invention is that the lithium battery is provided with a USB interface thereon and can be used as a mobile power pack for charging electronic products such as a mobile phone.

The invention provides the following beneficial effects:

The cloth cover and the heating sheet are easy to disassemble, replace and wash as a configuration easy to disassemble is used between them;

The heating sheet provides a good waterproof, insulating, flame retardant and wear resistant performance, a long service life and high safety.

The invention may be used both as a sleeping bag and a mattress cover. In either case, it is capable of heating. It may be used as an electric blanket in winter. It is versatile.

In a case that the alloy fiber is adopted for the heating material, there may be characteristics of foldability, washability and sewability. Furthermore, the alloy fiber is soft and light.

The flexible heating sheet may have a number and a position which may be arbitrarily adjusted as required, so as to satisfy use requirements of different people under different circumstances.

A plurality of temperature grades are provided, which can be selected as required; moreover, it is possible to provide an automatic temperature control function for keeping a suitable temperature all night.

### BRIEF DESCRIPTION OF DRAWINGS

In order to more clearly illustrate technical solutions of particular embodiments in the invention and of the prior art, drawings which are needed for description of the particular embodiments or the prior art will be briefly introduced hereinafter. Apparently, drawings below merely show some embodiments of the invention, and other drawings can also be obtained, in light of these drawings, by those skilled in the art without paying any creative effort.

FIG. 1 is a schematic view of the structure of a first electrothermal mattress cover provided by an embodiment of the invention.

FIG. 2 is a schematic view of the cloth cover for the upper surface of the electrothermal mattress cover as shown in FIG. 1.

FIG. 3 is a schematic view of the heating sheet of the electrothermal mattress cover as shown in FIG. 1.

FIG. 4 is a schematic view of the structure of a second electrothermal mattress cover provided by an embodiment of the invention.

FIG. 5 is a schematic view of the cloth cover of the electrothermal mattress cover as shown in FIG. 4.

FIG. 6 is a schematic view of the structure of the electrothermal sleeping bag/mattress cover provided by an embodiment of the invention.

FIG. 7 is a schematic view of the structure of the heating sheet of the electrothermal sleeping bag/mattress cover provided by an embodiment of the invention.

FIG. 8 is a schematic view in which the electrothermal sleeping bag/mattress cover provided by an embodiment of the invention is unfolded.

FIG. 9 is a structural schematic view of a temperature control sleeping bag provided in an embodiment of the invention.

FIG. 10 is a cross section schematic view of a flexible heating sheet.

### REFERENCE SIGNS

1—cloth cover; 101—corner connecting piece;
102—large opening; 103—small opening;
2—heating sheet; 201—heating wire;
202—fixing strap; 203—outgoing end;
21—cloth cover; 2101—first long side;
2102—first short side; 2103—second long side;
2104—second short side; 2105—upper surface of the cloth cover;
2106—lower surface of the cloth cover;
22—heating sheet; 2201—heating wire;
2202—outgoing end;
31—upper layer of the sleeping bag; 32—lower layer of the sleeping bag;
321—inner layer of the lower layer; 322—outer layer of the lower layer;
33—flexible heating sheet; 331—upper cotton cloth layer;
332—alloy fiber layer; 333—lower cotton cloth layer;
34—temperature control device; 35—lithium battery.

### DETAILED DESCRIPTION OF EMBODIMENTS

The technical solutions of the invention will be described clearly and completely hereinafter, in conjunction with drawings. Apparently, some but not all of embodiments of the invention are described. All of the other embodiments, obtained by those skilled in the art based on the embodiments of the invention without paying any creative effort, fall within the scope of protection of the invention.

In the description of the invention, it should be noted that orientational or positional relationships indicated by terms, such as “center”, “upper”, “lower”, “left”, “right”, “vertical”, “horizontal”, “inner”, and “outer”, are based on the orientational or positional relationships shown in the drawings, merely for facilitating the description of the invention and simplifying the description, rather than indicating or implying that the related devices or elements have to be in the specific orientation or configured and operated in the specific orientation, therefore they shall not be construed as limiting the invention. Furthermore, terms, such as “first”, “second” and “third”, are only used for illustrative purposes, and shall not be construed as indicating or implying a relative importance.

In the description of the invention, it should be noted that, terms, such as “install”, “connect” and “connection”, should be broadly interpreted, unless specified and defined otherwise. For example, it may be a fixed connection, a detachable connection, or being integrated; or it may be a mechanical connection or an electrical connection; or it may be a direct connection, an indirect connection through an intermediate medium, or it may be an inner communication between two elements. For those skilled in the art, specific meanings of the above terms in the invention can be understood based on specific situations.

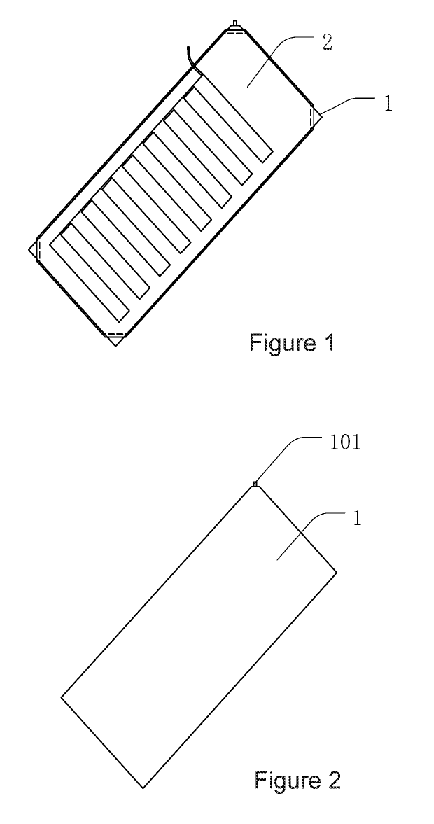

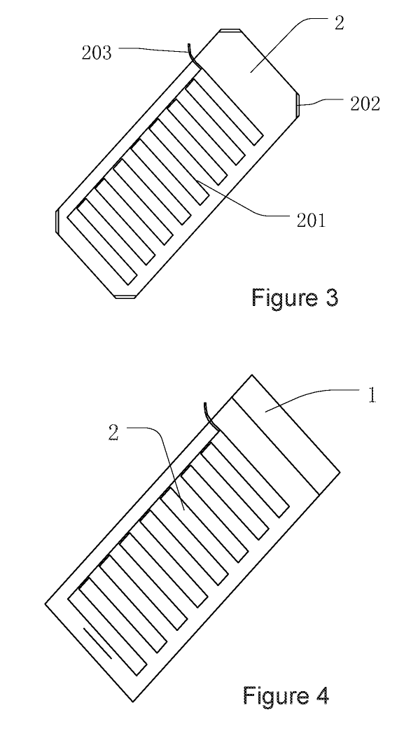

FIG. 1 is a schematic view of the structure of a first electrothermal mattress cover provided by an embodiment of the invention; FIG. 2 is a schematic view of the cloth cover for the upper surface of the electrothermal mattress cover as shown in FIG. 1; and FIG. 3 is a schematic view of the heating sheet of the electrothermal mattress cover as shown in FIG. 1.

As shown in FIG. 1-3, the electrothermal mattress cover includes a cloth cover 1 and a heating sheet 2;

The heating sheet 2 includes a heating wire 201 fixed within the interlayer between two adhesive tapes, and an outer cover wrapping the two adhesive tapes; the outgoing end 203 of the heating wire 201 goes through the adhesive tapes and the outer cover, and the heating wire 201 is bound to the outer cover by waterproof binding materials.

The tapes provide good waterproof, insulating and flame retardant effects, improving effectively the safety of the heating sheet in use.

The upper surface of the heating sheet 2 is provided with fixing straps 202 respectively at its corners. Both ends of the fixing straps 202 are fixed onto the upper surface of the heating sheet 2, forming fixing rings with the upper surface of the heating sheet 2.

The cloth cover 1 is provided on the upper surface of the heating sheet 2, and the corners of the cloth cover 1 are threaded through the fixing rings formed by the fixing straps 202 and the upper surface of the heating sheet 2. Corner connecting pieces 101 are provided at the corners of the cloth cover 1 for connecting the fixing straps, so as to fix the cloth cover 1 and the heating sheet 2 in the form of adhesion, binding, concealed button, Velcro or sewing or other forms that enable quick connection and disassembly between the materials.

The types of the heating wire 201 include a silicone heating wire, a carbon fiber heating wire, a Teflon alloy heating wire and a glass fiber heating wire. As required by the design, the heating wire 201 may be arranged or wound in an S-shape configuration, clip-shape configuration or grid-shape configuration.

The heating wire 201 may also be substituted with an alloy fiber layer.

The alloy fiber layer is made of alloy fiber which generally refers to a material used for producing soft industrial metal. Due to the unique chemical element association, the alloy fiber has good electrical conductivity and thermal conductivity, high strength, high elasticity, flexibility, wear resistance and corrosion resistance, and at the same time, the alloy fiber has for example properties of shielding, anti-magnetism and anti-radiation, and is unlikely to produce an electrostatic effect.

The alloy fiber is used as a heating component which is featured by quick heating, high electrothermal conversion efficiency, foldability, washability and sewability. Besides, the alloy fiber can improve the sleep quality because it is soft and light, and feels good.

The cloth cover 1 may be made of a single layer of material or multiple layers of laminated materials, wherein the single layer of material is a flexible material including knitted fabric and lint, and the multiple layers of materials are, from top to bottom, respectively flexible material including knitted fabric and lint, sponge and cotton insulation.

The outgoing end 203 of the heating sheet 2 is used for power connection.

In a preferred solution of the embodiment, a power source and a temperature control device are further included. The outgoing end 203 of the heating wire 201 is connected with the power source via the temperature control device.

The power source may be a high-capacity lithium battery which is suitable for outdoor use.

The temperature control device is provided with adjustable grades which control the output power of the power source. In the embodiment, the temperature control device has three grades: a low grade corresponding to temperatures from 26 degrees Celsius to 32 degrees Celsius; a middle grade corresponding to temperatures from 32 degrees Celsius to 36 degrees Celsius; and a high grade corresponding to temperatures from 36 degrees Celsius to 45 degrees Celsius. In the case of the high grade, the lithium battery may provide power for 8 hours, which fully satisfies the sleep time requirement of the user.

The heating sheet 2 may be provided with a plurality of temperature sensors connected with the temperature control device, enabling automatic adjustment of temperature grades.

The individual grades of the temperature control device correspond to different threshold temperatures. The actual temperature of the heating sheet is detected by the temperature sensors, and the heating operation is started or stopped when the detected actual temperature reaches the corresponding threshold temperature, so that the heating sheet can always remain at a suitable set temperature automatically.

A positive temperature coefficient thermistor may also be connected to the heating wire 201, for substitution of the temperature sensors. The temperature of the heating sheet is controlled by the resistance value of the positive temperature coefficient thermistor which is adjusted by the temperature change.

As the temperature of the heating sheet increases to a set value, the resistance of the positive temperature coefficient thermistor increases significantly, thereby reducing the intensity of current and suspending the heating. After the temperature of the heating sheet decreases, the resistance of the positive temperature coefficient thermistor decreases accordingly, thereby increasing the intensity of current and improving the heating strength.

The temperature control is achieved by the positive temperature coefficient thermistor with its own properties, thereby simplifying the circuit and increasing the reliability of the temperature control device.

The lithium battery may also be provided with a USB interface so that it may be used as a mobile power pack for charging electronic products as a mobile phone.

The temperature control device may also be provided with indicator lights, a display screen and lighting equipment for use in the night.

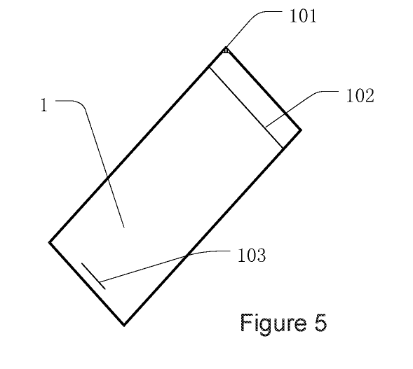

Another embodiment of the invention is as shown in FIGS. 4 and 5.

Specifically, FIG. 4 is a schematic view of the structure of a second electrothermal mattress cover provided by an embodiment of the invention; FIG. 5 is a schematic view of the cloth cover of the electrothermal mattress cover as shown in FIG. 4.

As shown in FIG. 4 and FIG. 5, the electrothermal mattress cover includes a cloth cover 1 and a heating sheet 2 in the embodiment.

See the foregoing embodiment for the internal structure and material selection of the heating sheet 2, and the material selection and arrangement of the heating wire 201. It is unnecessary to go into details here. It is not necessary to provide fixing straps 202 on the surface of the heating sheet 2.

The cloth cover 1 is of a bag structure and is provided on one side of the back of the cloth cover 1 with a large opening 102 allowing the heating sheet 2 to enter, and provided on the other side of the back of the cloth cover 1 with a small opening 103 allowing the outgoing end 203 of the heating sheet 2 to enter or exit.

An opening connecting piece is provided at the large opening 102 for the heating sheet 2 to enter or exit and for enclosure at the large opening 102. The opening connecting piece may be a zipper, rope, button, snap fastener or Velcro as required by use, as long as it is easy to open and close the large opening 102.

Corner connecting pieces 101 are provided at the corners of the cloth cover 1, for connecting the heating sheet. The corner connecting pieces 101 may be in the form of ropes, snap fasteners or Velcro or other forms that enable quick connection and disassembly between the materials.

The upper surface of the cloth cover 1 may be made of a single layer of material or multiple layers of laminated materials, wherein the single layer of material is a flexible material including knitted fabric and lint, and the multiple layers of materials are, from top to bottom, respectively flexible material including knitted fabric and lint, sponge and cotton insulation.

The lower surface of the cloth cover 1 is made of a single layer of material which is waterproof and wear resistant.

The design of other parts may also refer to the foregoing embodiment and it is not to go into details.

A configuration easy to disassemble is used between the cloth cover and the heating sheet of the invention, making them easy to disassemble, replace and wash;

The heating sheet provides a good waterproof, insulating, flame retardant and wear resistant performance, effectively improving the service life, and it is very safe.

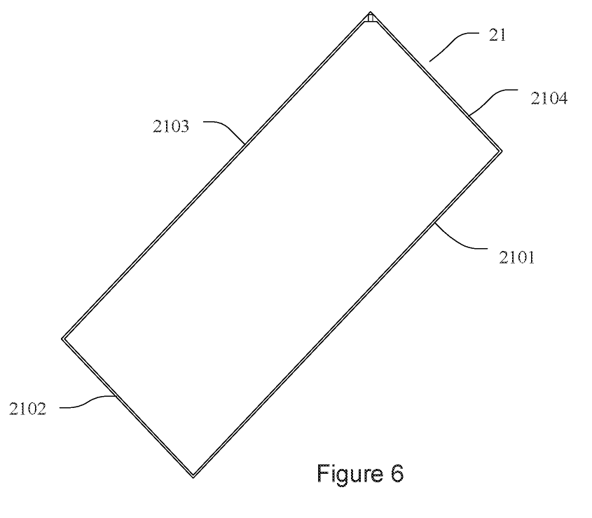

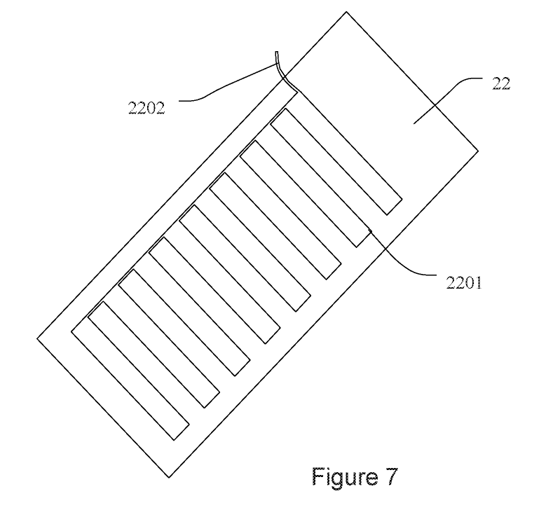

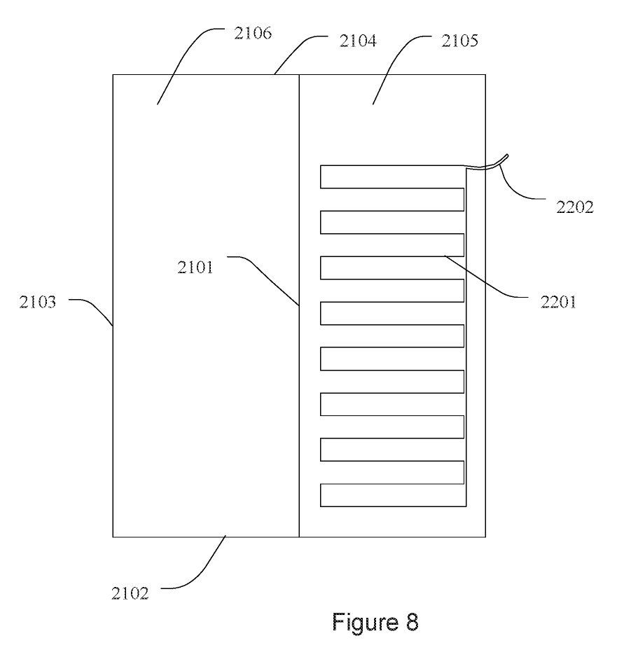

FIG. 6 is a schematic view of the structure of the electrothermal sleeping bag/mattress cover provided by an embodiment of the invention; FIG. 7 is a schematic view of the structure of the heating sheet of the electrothermal sleeping bag/mattress cover provided by an embodiment of the invention; and FIG. 8 is a schematic view in which the electrothermal sleeping bag/mattress cover provided by an embodiment of the invention is unfolded.

As shown in FIG. 6-8, the electrothermal sleeping bag/mattress cover includes two major parts, a cloth cover 21 and a heating sheet 22.

The heating sheet 22 includes a heating wire 2201 fixed within the interlayer between two adhesive tapes, and an outer cover wrapping the two adhesive tapes; the outgoing end 2202 of the heating wire 2201 goes through the adhesive tapes and the outer cover, and the heating wire 2201 is bound to the outer cover by waterproof binding materials so that they are sealed.

The heating sheet is provided with adhesive tapes in it which provide a waterproof, insulating and flame retardant effects, and are protective for the heating wire, making them very safe.

The cloth cover 21 includes two pieces, the upper surface 2105 of the cloth cover and the lower surface 2106 of the cloth cover; wherein the lower surface 2106 of the cloth cover includes four sides, respectively a first long side 2101, a first short side 2102, a second long side 2103 and a second short side 2104.

One long side of the upper surface 2105 of the cloth cover is fixedly connected with the first long side 2101 of the lower surface 2106 of the cloth cover by sewing. One short side and the other long side of the upper surface 2105 of the cloth cover are connected with the first short side 2102 and the second long side 2103 of the lower surface 2106 of the cloth cover by zippers. The other short side of the upper surface 2105 of the cloth cover and the second short side 2104 of the lower surface 2106 of the cloth cover may not be connected so that an opening is formed. Thus, the cloth cover 21 may be unzipped and opened to be planar, or it may be folded and zipped, forming a bag structure, so that it may be used as a sleeping bag.

The heating sheet 22 is provided on the inner side of the upper surface 2105 of the cloth cover by sewing or attachment.

The types of the heating wire 2201 include a silicone heating wire, a carbon fiber heating wire, a Teflon alloy heating wire and a glass fiber heating wire. As required by the design, the heating wire 2201 may be arranged or wound in an S-shape configuration, clip-shape configuration or grid-shape configuration.

The heating wire 2201 may also be substituted with an alloy fiber layer.

The alloy fiber layer is made of alloy fiber, which generally refers to a material used for producing soft industrial metal. Due to the unique chemical element association, the alloy fiber has good electrical conductivity and thermal conductivity, high strength, high elasticity, flexibility, wear resistance and corrosion resistance, and at the same time, the alloy fiber has for example properties of shielding, anti-magnetism and anti-radiation, and is unlikely to produce an electrostatic effect.

The alloy fiber is used as a heating component which is featured by quick heating, high electrothermal conversion efficiency, foldability, washability and sewability. Besides, the alloy fiber can improve the sleep quality because it is soft and light, and feels good.

The upper surface 2105 cloth cover may be made of a single layer of material or multiple layers of laminated materials, wherein the single layer of material is a flexible material including knitted fabric and lint, and the multiple layers of materials are, from top to bottom, respectively flexible material including knitted fabric and lint, sponge and cotton insulation.

The outgoing end 2202 of the heating sheet 22 is used for power connection.

In a preferred solution of the embodiment, a power source and a temperature control device are further included. The outgoing end 2202 of the heating wire 2201 is connected with the power source via the temperature control device.

The power source may be a high-capacity lithium battery which is suitable for outdoor use.

The temperature control device is provided with adjustable grades which control the output power of the power source. In the embodiment, the temperature control device has three grades: a low grade corresponding to temperatures from 26 degrees Celsius to 32 degrees Celsius; a middle grade corresponding to temperatures 32 degrees Celsius-36 degrees Celsius; temperature corresponding to the high grade: 36 degrees Celsius-45 degrees Celsius. In the case of the high grade, the lithium battery may provide power for 8 hours, which fully satisfies the sleep time requirement of the user.

The heating sheet 22 may be provided with a plurality of temperature sensors which are connected with the temperature control device, enabling automatic adjustment of temperature grades.

The individual grades of the temperature control device correspond to different threshold temperatures. The actual temperature of the heating sheet is detected by the temperature sensor, and the heating operation is started or stopped when the detected actual temperature reaches the corresponding threshold temperature, so that the flexible heating sheet can always remain at a suitable set temperature automatically.

A positive temperature coefficient thermistor may also be connected to the heating wire 2201, for substitution of the temperature sensors. The temperature of the heating sheet is controlled by the resistance value of the positive temperature coefficient thermistor which is adjusted by the temperature change.

As the temperature of the heating sheet increases to a set value, the resistance of the positive temperature coefficient thermistor increases significantly, thereby reducing the intensity of current and suspending the heating. After the temperature of the heating sheet decreases, the resistance of the positive temperature coefficient thermistor decreases accordingly, thereby increasing the intensity of current and improving the heating strength.

The temperature control is achieved by the positive temperature coefficient thermistor with its own properties, thereby simplifying the circuit and increasing the reliability of the temperature control device.

The lithium battery may also be provided with a USB interface so that it may be used as a mobile power pack for charging electronic products such as a mobile phone.

The temperature control device may also be provided with indicator lights, a display screen and lighting equipment for use in the night.

In the preferred solution of the embodiment, a hollow interlayer is provided within the upper surface 2105 of the cloth cover. An opening is also provided on the inner side of the upper surface 2105 of the cloth cover allowing the heating sheet 22 to enter or exit. An opening connecting piece is provided at the opening.

The opening connecting piece may be for example connected by a zipper, rope, button, snap fastener or Velcro, as long as it is easy to open and close.

Providing an opening makes it easy for the heating sheet to enter or exit, so that it is easy to wash the cloth cover.

The invention may be used both as a sleeping bag and a mattress cover. In either case, it is capable of heating, realizing the combination of sleeping bag, electric blanket and mattress cover.

The invention provides a temperature control sleeping bag, and the invention is described in detail by way of several embodiments.

First Embodiment of Temperature Control Sleeping Bag:

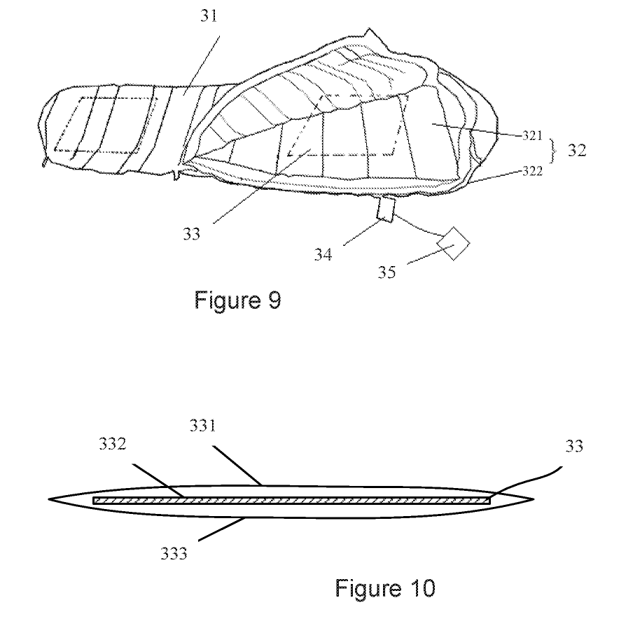

FIG. 9 is a structural schematic view of a temperature control sleeping bag provided in an embodiment of the invention; and FIG. 10 is a cross section schematic view of a flexible heating sheet.

As shown in FIG. 9, the temperature control sleeping bag is made up of an upper layer 31 of the sleeping bag and a lower layer 32 of the sleeping bag by sewing, and an opening for user to enter or exit is provided between the upper layer 31 of the sleeping bag and the lower layer 32 of the sleeping bag.

The lower layer 32 of the sleeping bag is made up of an inner layer 321 of the lower layer and an outer layer 322 of the lower layer by sewing, and at least one flexible heating sheet 33 is provided fixedly in an interlayer between the inner layer 321 of the lower layer and the outer layer 322 of the lower layer.

The flexible heating sheet 33 includes a cloth bag made up of an upper cotton cloth layer 331 and a lower cotton cloth layer 333 by sewing, and an alloy fiber layer 332 provided inside the cloth bag.

The alloy fiber layer 332 is made of alloy fiber which generally refers to a material used for producing soft industrial metal. Due to the unique chemical element association, the alloy fiber has good electrical conductivity and thermal conductivity, high strength, high elasticity, flexibility, wear resistance and corrosion resistance, and at the same time, the alloy fiber has for example properties of shielding, anti-magnetism and anti-radiation, and is unlikely to produce an electrostatic effect.

In a case that the alloy fiber is adopted for the heating component, there may be characteristics of fast heating, high electricity-heat transformation rate, foldability, washability and sewability. Furthermore, the alloy fiber is soft and light, which makes the user feel better and enables to improve the sleeping quality.

The alloy fiber layer 332 is connected with a conductive wire, and is outgoing from the lower layer 32 of the sleeping bag to electrically connect with a lithium battery 35 through the temperature control device 34.

The temperature control device 34 is provided with adjustable grades, to control the output power of the lithium battery 35. In the embodiment, the temperature control device 34 has three grades: a low grade corresponding to temperatures from 26 degrees Celsius to 32 degrees Celsius; a middle grade corresponding to temperatures from 32 degrees Celsius to 36 degrees Celsius; and a high grade corresponding to temperatures from 36 degrees Celsius to 45 degrees Celsius. In the case of the high grade, the lithium battery 35 may provide power for 8 hours, which fully satisfies the sleep time requirement of the user.

In the preferred solution of the embodiment, the lithium battery 35 may also be provided with a USB interface, and can be used as a mobile power pack for charging electronic products such as a mobile phone.

In the preferred solution of the embodiment, the temperature control device 34 may also be provided with an indicator light, a display screen, a lighting device and other components thereon, so as to facilitate the usage at night.

Second Embodiment of Temperature Control Sleeping Bag:

The temperature control sleeping bag in the embodiment is also made up of an upper layer of the sleeping bag and a lower layer of the sleeping bag by sewing, and an opening for user to enter or exit is provided between the upper layer of the sleeping bag and the lower layer of the sleeping bag.

The lower layer of the sleeping bag is made up of an inner layer of the lower layer and an outer layer of the lower layer by sewing, and at least one opening is provided at a place where the inner layer of the lower layer and the outer layer of the lower layer are connected by sewing. At least one flexible heating sheet is provided fixedly in an interlayer between the inner layer of the lower layer and the outer layer of the lower layer.

The interlayer may be opened by the opening, so that a position of the flexible heating sheet can be adjusted freely in accordance with a body shape or a requirement of the user.

Connection structures for facilitating the opening and closing such as a zipper, a rope, a snap fastener or a button are provided at the opening, for, on one hand, preventing the flexible heating sheet from missing, and on the other hand, facilitating a user to take out or move the flexible heating sheet.

The flexible heating sheet includes a cloth bag made up of an upper cotton cloth layer and a lower cotton cloth layer by sewing, and an alloy fiber layer provided inside the cloth bag.

The connection relationships between the flexible heating sheet and the temperature control device as well as the lithium battery are the same as those in the first embodiment, and thus detailed description is omitted here.

Third Embodiment of Temperature Control Sleeping Bag:

Based on the Second Embodiment, an outer surface of a lower cotton cloth layer of the flexible heating sheet is provided with a hook layer of Velcro, and an inner surface of an outer layer of the lower layer is covered with a fiber loop layer of the Velcro, thus implementing a connection by the hook layer and the fiber loop layer.

By the Velcro structure, the flexible heating sheet may be fixed at a set position, which prevents the flexible heating sheet from moving or shifting; and the flexible heating sheet can also be moved or taken out conveniently when the position needs to be adjusted or the sleeping bag needs to be washed.

There may be provided with two flexible heating sheets, both of which are provided in the interlayer of the lower layer of the sleeping bag, and positions where the two flexible heating sheets locate correspond to the waist and the feet of a human body, respectively.

The feet of a person presents low temperature during the sleeping of the person, and thus the sleeping quality of the person may be improved if a heating sheet is provided at the feet.

In other solution of the invention, the upper layer of the sleeping bag may also be made of an inner layer and an outer layer by sewing, and a flexible heating sheet is provided in an interlayer between the inner layer and the outer layer. Thus, the bottom of the body can be heated, and the top of the body can also be heated at the same time, and the thermal insulation performance of the sleeping bag is improved.

Fourth Embodiment of Temperature Control Sleeping Bag:

The embodiment may adopt any sleeping bag structure and any form of flexible heating sheet in the First Embodiment, the Second Embodiment and the Third Embodiment.

Unlike the preceding three embodiments, the temperature control sleeping bag in the embodiment further includes a temperature sensor; there are a plurality of temperature sensors, which are provided inside the individual flexible heating sheets, respectively, and the temperature sensor is connected with the temperature control device, thus implementing an automatic adjustment of the temperature grades.

The individual grades of the temperature control device correspond to different threshold temperatures, respectively. The actual temperature of the flexible heating sheet is detected by the temperature sensor, and the heating is started or stopped when the detected actual temperature reaches the corresponding threshold temperature, so that the flexible heating sheet can always remain at a suitable set temperature automatically.

In the embodiment, there may be one temperature control device, which controls all the flexible heating sheets to work synchronously; or the temperature control device has a number equal to and corresponding to that of the flexible heating sheet, for controlling the corresponding flexible heating sheet to work, respectively, implementing a temperature adjustment by area, and thus improving sleeping comfort.

Fifth Embodiment of Temperature Control Sleeping Bag:

The embodiment may adopt any sleeping bag structure and any form of flexible heating sheet in the First Embodiment, the Second Embodiment and the Third Embodiment.

Unlike the preceding three embodiments, the temperature control device in the embodiment is provided with a positive temperature coefficient thermistor therein, and the resistance of the positive temperature coefficient thermistor is adjusted with a change of temperature, to control the temperature of the flexible heating sheet.

As the temperature of the flexible heating sheet increases to a set value, the resistance of the positive temperature coefficient thermistor increases significantly, thereby reducing the intensity of current and suspending the heating of the alloy fiber. After the temperature of the flexible heating sheet decreases, the resistance of the positive temperature coefficient thermistor decreases accordingly, thereby increasing the intensity of current and improving the heating strength of the alloy fiber.

The temperature control is implemented by the positive temperature coefficient thermistor with its own properties, thereby simplifying the circuit and increasing the reliability of the temperature control device.

In the embodiment, there may be one temperature control device which controls all the flexible heating sheets to work synchronously; or the temperature control device has a number equal to and corresponding to that of the flexible heating sheet, for controlling the corresponding flexible heating sheet to work, respectively, implementing a temperature adjustment by area, and thus improving sleeping comfort.

Finally, it should be noted that, all of the above embodiments are only illustrative of the technical solutions of the invention, and not limiting. Although the invention have been detailed with reference to the foregoing embodiments, those skilled in the art shall understand that they may make modifications to the technical solutions as illustrated by those embodiments or substitute a part or all of the technical features with equivalents. Such modifications and substitutions shall not cause the essence of the respective technical solutions to depart from the scope of the technical solutions as illustrated by those embodiments of the invention.

1. An electrothermal mattress cover, comprising a cloth cover and a heating sheet;
wherein the cloth cover at least covers or wraps an upper surface of the heating sheet; the cloth cover is provided with corner connecting pieces at corners of the cloth cover, for connecting the heating sheet;
the heating sheet comprises a heating wire fixed within an interlayer between two adhesive tapes, and an outer cover wrapping the two adhesive tapes; an outgoing end of the heating wire goes through the tapes and the outer cover; the heating wire is bound to the outer cover by waterproof binding materials; and
the outgoing end of the heating sheet is used for power connection.

2. The electrothermal mattress cover according to claim 1, wherein the upper surface of the heating sheet is provided with fixing straps respectively at corners of the upper surface, and both ends of the fixing straps are fixed onto the heating sheet, cooperating with the upper surface of the heating sheet to form fixing rings;
the cloth cover is provided on the upper surface of the heating sheet, and the corners of the cloth cover are threaded through the fixing rings and fixed.

3. The electrothermal mattress cover according to claim 1, wherein the cloth cover is of a bag structure, the cloth cover is provided, on one side of a back of the cloth cover, with a large opening allowing the heating sheet to enter, and provided, on the other side of the back, with a small opening allowing the outgoing end of the heating sheet to enter or exit, and an opening connecting piece is provided at the large opening.

4. The electrothermal mattress cover according to claim 3, wherein the corner connecting pieces are ropes, snap fasteners or Velcro; the opening connecting piece is a zipper, rope, button, snap fastener or Velcro.

5. The electrothermal mattress cover according to claim 1, wherein the types of the heating wire comprise a silicone heating wire, a carbon fiber heating wire, a Teflon alloy heating wire and a glass fiber heating wire.

6. The electrothermal mattress cover according to claim 1, wherein the upper surface of the cloth cover is made of a single layer of material or multiple layers of laminated materials.

7. The electrothermal mattress cover according to claim 6, wherein the single layer of material is a flexible material comprising knitted fabric and lint;
the multiple layers of laminated materials are, from top to bottom, respectively flexible material comprising knitted fabric and lint, sponge and cotton insulation.

8. The electrothermal mattress cover according to claim 1, wherein the heating wire is arranged or wound in an S-shape configuration, clip-shape configuration or grid-shape configuration.

9. The electrothermal mattress cover according to claim 1, further comprising a power source and a temperature control device;
wherein the outgoing end of the heating wire is connected with the power source via the temperature control device;
the power source is a lithium battery and provided with a USB interface.

10. An electrothermal sleeping bag/mattress cover, comprising a cloth cover and a heating sheet;
wherein the cloth cover comprises an upper surface of the cloth cover and a lower surface of the cloth cover; one long side of the upper surface of the cloth cover and one long side of the lower surface of the cloth cover are fixedly connected by sewing; the other long side and at least one short side of the upper surface of the cloth cover and those of the lower surface of the cloth cover are connected in an openable and closable manner;
the heating sheet is provided on the inner side of the upper surface of the cloth cover by sewing or attachment.

11. The electrothermal sleeping bag/mattress cover according to claim 10, wherein the other long side and at least one short side of the upper surface of the cloth cover and those of the lower surface of the cloth cover are connected by zippers.

12. The electrothermal sleeping bag/mattress cover according to claim 10, wherein an opening is provided on the inner side of the upper surface of the cloth cover, allowing the heating sheet to enter or exit, and an opening connecting piece is provided at the opening.

13. A temperature control sleeping bag, comprising:
an inner layer, an outer layer, at least one flexible heating sheet, a power source and at least one temperature control device;
the flexible heating sheet comprising a cloth bag and alloy fiber provided inside the cloth bag;
the flexible heating sheet being provided within an interlayer formed between the inner layer and the outer layer, and the flexible heating sheet being electrically connected with the power source through the temperature control device.

14. The temperature control sleeping bag according to claim 13, wherein at least one opening is provided at a place where the inner layer and the outer layer are connected, and a zipper, a rope, a snap fastener or a button is provided at the opening, for implementing opening or closing of the opening.

15. The temperature control sleeping bag according to claim 14, wherein one surface of the cloth bag is provided with a hook layer of Velcro, an inner surface of the outer layer is covered with a fiber loop layer of the Velcro, thus making a position of the flexible heating sheet adjustable inside the interlayer.

16. The temperature control sleeping bag according to claim 13, wherein number of the at least one temperature control device is one, which controls all the flexible heating sheets to work synchronously; or the number of the at least one temperature control device is equal to that of the flexible heating sheets, for respectively controlling the corresponding flexible heating sheet to work.

17. The temperature control sleeping bag according to claim 13, wherein there are two flexible heating sheets which are provided in an interlayer of a lower layer of the sleeping bag, and positions where the two flexible heating sheets locate correspond to the waist and the feet of a human body, respectively.

18. The temperature control sleeping bag according to claim 13, further comprising a temperature sensor, wherein the temperature sensor is provided inside the flexible heating sheet, and the temperature sensor is connected with the temperature control device, for implementing an adjustment of temperature grades.

19. The temperature control sleeping bag according to claim 13, wherein the temperature control device is provided with a positive temperature coefficient thermistor therein, and resistance of the positive temperature coefficient thermistor is adjusted with a change of temperature, for implementing an adjustment of temperature grades.

20. The temperature control sleeping bag according to claim 13, wherein the power source is a lithium battery, and the lithium battery is provided with a USB interface thereon.
